(19) United States
(12) Patent Application Publication
(10) Pub. No.: US 2024/0387965 A1
(43) Pub. Date: Nov. 21, 2024

(54) LITHIUM-ION BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Nozomi TATEYAMA, Okazaki-shi (JP); Tsuyoshi ASANO, Toyota-shi (JP); Masahiro UCHIMURA, Miyoshi-shi (JP); Shigeru MATSUMOTO, Toyohashi-shi (JP); Yasuaki NAGANO, Kosai-shi (JP)

(21) Appl. No.: 18/611,736

(22) Filed: Mar. 21, 2024

(30) Foreign Application Priority Data
May 17, 2023 (JP) 2023-081770

(51) Int. Cl. H01M 50/59; C03C 3/078; C08K 3/40; H01M 10/0525; H01M 50/172; H01M 50/586

(52) U.S. Cl. CPC H01M 50/59; C03C 3/078; C08K 3/40; H01M 10/0525; H01M 50/172; H01M 50/586

(57) ABSTRACT

A battery is a lithium-ion battery including a case, an electrode body and an electrolytic solution which are housed inside the case, and a resin member fixed to the case and having an inner exposed surface which is exposed inside the case. The electrolytic solution is a non-aqueous electrolytic solution containing fluorine. The resin member includes glass filler formed of glass which contains silicon oxide as a main body and added with group 2 elements. A number of atoms ratio of the group 2 elements to silicon in component elements of the glass filler is 0.12% or more and 65% or less.

### CROSS-REFERENCE TO RELATED APPLICATIONS

This application is based upon and claims the benefit of priority from the prior Japanese Patent Application No. 2023-081770 filed on May 17, 2023, the entire contents of which are incorporated herein by reference.

### BACKGROUND

### Technical Field

The present disclosure relates to a lithium-ion battery.

### Related Art

In a lithium-ion battery, an electrode body and an electrolytic solution are housed inside a case. A part of the case in the thus configured battery is fixed with a resin member for disposing a terminal member and for other purposes. A part of the resin member constitutes an inner exposed surface that is exposed inside the case. As the resin member, one added with glass filler may be used. As a filler-added resin, for example, one described in Japanese unexamined patent application publication No. 2013-035950 may be utilized.

### SUMMARY

### Technical Problems

As the electrolytic solution included in this type of the battery, a non-aqueous electrolytic solution containing fluorine can be used. In that case, however, the filler-added resin could be degraded. This degradation in the filler-added resin happens when moisture gets intruded in the non-aqueous electrolytic solution. This is because the fluorine in the non-aqueous electrolytic solution and the intruded moisture react to generate hydrogen fluoride. The hydrogen fluoride dissolves glass, and thus the glass filler gets dissolved and lost by the hydrogen fluoride.

A problem to be solved by the present disclosure is to provide a lithium-ion battery that can inhibit acceleration in degradation of a resin member even if a non-aqueous electrolytic solution containing fluorine is used.

### Means of Solving the Problems

A lithium-ion battery according to one aspect of the present disclosure comprises a case; an electrode body and an electrolytic solution housed inside the case; and a resin member being fixed to the case and having an inner exposed surface which is exposed inside the case, wherein the electrolytic solution is a non-aqueous electrolytic solution containing fluorine, the resin member includes glass filler formed of glass which contains silicon oxide as a main body and is added with group 2 elements, and a number of atoms ratio of the group 2 elements to silicone in component elements of the glass filler is 0.12% or more and 65% or less.

In the lithium-ion battery according to the above aspect, the glass filler is compounded in the resin member, and thereby a linear expansion coefficient and an elastic modulus of the resin member are adjusted. Accordingly, the linear expansion coefficient and the elastic modulus of the resin member can be made similar to a linear expansion coefficient and an elastic modulus of the case. On the other hand, when moisture gets intruded in the electrolytic solution, hydrogen fluoride generated by reaction of fluorine in the electrolytic solution with moisture would dissolve the glass filler. However, the group 2 elements added to the glass filler inhibit such dissolution. Accordingly, the properties of the resin member can be maintained even if moisture gets intruded.

In the lithium-ion battery according to the above aspect, preferably, at least a part of the group 2 elements is magnesium, and a mass ratio of magnesium to silicone in the component elements of the glass filler is 0.1% or more and 25% or less. When magnesium is used as the group 2 elements, there is higher effect of inhibiting dissolution of the glass filler due to hydrogen fluoride.

In the lithium-ion battery according to the above aspect, alternatively, at least a part of the group 2 elements may be calcium, and a mass ratio of calcium to silicone in the component elements of the glass filler may be 0.17% or more and 81% or less. When the group 2 element is calcium, there is similar effect of inhibiting dissolution of the glass filler due to hydrogen fluoride.

In the lithium-ion battery according to any one of the above aspects, preferably, the lithium-ion battery is provided with a terminal member that is connected to the electrode body inside the case and penetrates the case to be partly exposed outside the case, and the resin member is configured to insulate the case and the terminal member. This configuration can achieve long-term maintenance of insulating performance and hermetic-closing performance by the resin member between the case and the terminal member.

According to the present disclosure, there is provided a lithium-ion battery which inhibits acceleration of degradation in a resin member even if a non-aqueous electrolytic solution containing fluorine is used.

### BRIEF DESCRIPTION OF THE DRAWINGS

FIG. 1 is a sectional view of a battery in an embodiment;

FIG. 2 is a partial enlarged view of a part of FIG. 1;

FIG. 3 is a graph indicating a maximum depth of corrosion of glass filler corroded by impregnation of a resin member into an electrolytic solution;

FIG. 4 is a graph indicating changes in an elastic modulus of a resin member changed by impregnation of the resin member into the electrolytic solution; and

FIG. 5 is a graph indicating a relationship between an intrusion depth of fluorine intruded by impregnation of the resin member into the electrolytic solution and a temperature.

### DETAILED DESCRIPTION OF THE EXEMPLARY EMBODIMENTS

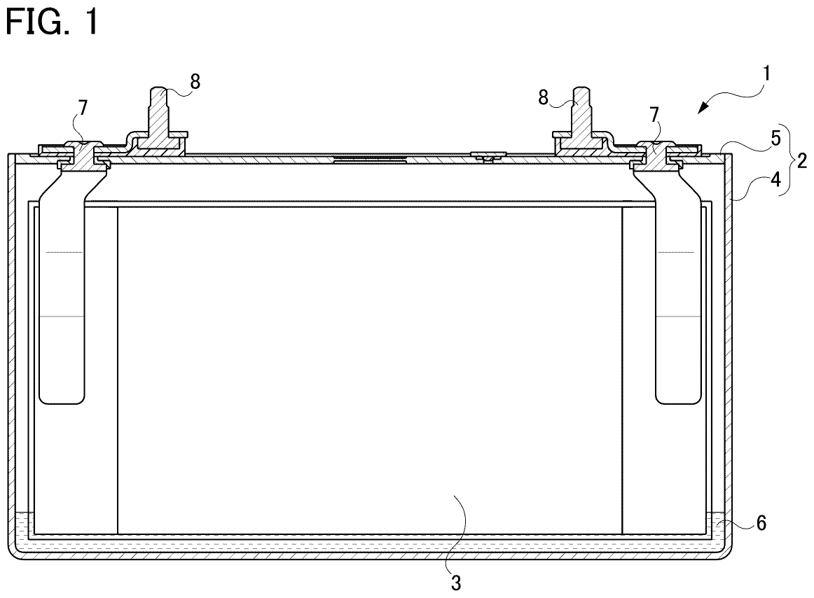

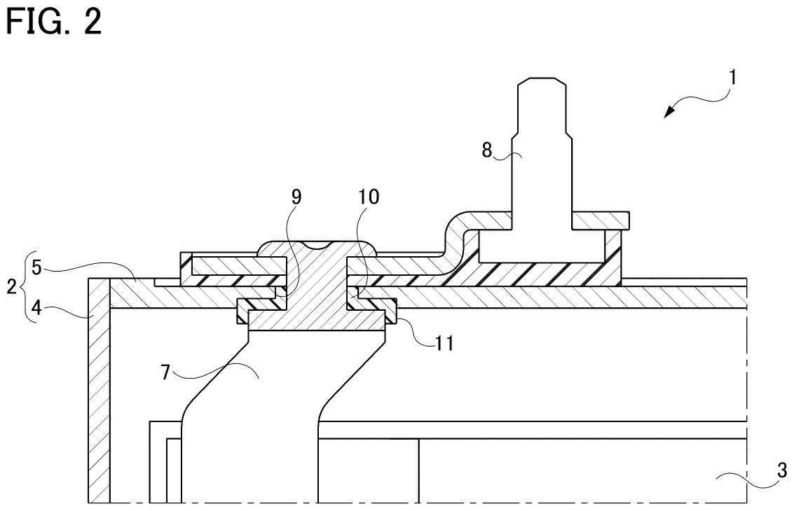

The present embodiment is an embodiment of the present disclosure embodied as a battery 1 shown in FIGS. 1 and 2. The battery 1 is configured by housing an electrode body 3 in a case 2. The case 2 is an exterior member constituting an outer appearance of the battery 1. In the present embodiment, the case 2 is made of metal such as aluminum. The case 2 is configured with a housing 4 and a lid 5. The electrode body 3 is formed by laminating positive and negative electrode plates.

In the case 2, not only the electrode body 3 but also an electrolytic solution 6 are housed. The electrolytic solution 6 exists as liquid substance in an inner space of the case 2 and also is soaked in the electrode body 3. The battery 1 is further provided with a terminal member 7. The terminal member 7 is provided to penetrate the case 2. The terminal member 7 is partly exposed outside the case 2. A part of the terminal member 7 inside the case 2 is connected to the electrode body 3. Another part of the terminal member 7 outside the case 2 is connected to an outer terminal 8. The battery 1 includes the two terminal members 7 and the two outer terminals 8 for a positive electrode and a negative electrode. Material of the terminal members 7 and the outer terminals 8 is aluminum or copper.

The lid 5 is formed with through holes 9 through which the terminal members 7 penetrate. The battery 1 further includes resin members 10. The resin members 10 are provided to be fixed to the case 2. Positions to which the respective resin members 10 are fixed in the case 2 are positions in the through holes 9 between the lid 5 and the terminal members 7. The resin members 10 have roles of separating an inner space from an outer space of the case 2 and insulating the case 2 from the terminal members 7. Each of the resin members 10 has an inner exposed surface 11 that is exposed inside the case 2.

The electrolytic solution 6 in the battery 1 of the present embodiment is described. In the present embodiment, a non-aqueous electrolytic solution containing fluorine is used as the electrolytic solution 6. Examples of a solvent and an electrolyte for the electrolytic solution 6 of the present embodiment are illustrated below.

Solvent: a polar organic solvent such as ethylene carbonate, propylene carbonate, and diethyl carbonate.

Electrolyte: fluorine containing salt such as lithium hexafluorophosphate and lithium tetrafluoroborate.

The resin member 10 in the battery 1 of the present embodiment is described. The resin member 10 of the present embodiment is a compound material in which glass filler is added to a base resin. A purpose of adding the glass filler is to adjust the linear expansion coefficient and the elastic modulus of the resin member 10. Adjustment of the linear expansion coefficient represents reduction in the linear expansion coefficient of the resin member 10. This adjustment is made to approximate the coefficient to a linear expansion coefficient of metal components such as the lid 5 and the terminal members 7. Adjustment of the elastic modulus represents increase in the elastic modulus of the resin member 10. Both adjustment contributes to improvement in endurance of the hermetic closing performance of the resin members 10 in the battery 1.

Types of resin usable for the base resin of the resin members 10 in the present embodiment are not specifically limited, but it is preferable to use the one having excellent thermal resistance and mechanical strength. For example, polyphenylenesulfide resin (hereinafter, referred as PPS resin), polyphenylene oxide resin, modified poly phenylene ether, and others are exemplified.

The glass filler of the resin member 10 of the present embodiment is minute fragments formed of glass. Each shape of the fragments is a short-fiber-like shape or a granular shape. Glass used for the glass filler in the present embodiment is formed of silicone oxide such as silicon dioxide as a main body, which is added with group 2 elements, especially, magnesium or calcium. The added group 2 elements are considered to be in an oxidative state in the glass. The glass may also contain aluminum for improvement in productivity and titanium and iron for improvement in acid resistance, both of which are only included by a small amount in the oxidative state.

The group 2 elements are added to the glass filler in the present embodiment for the purpose of improvement in the endurance of the resin members 10. As described above, fluorine containing salt is used as the electrolyte of the electrolytic solution 6 in the present embodiment. Accordingly, in the electrolytic solution 6, fluorine is included as a form of hexafluorophosphate ion or the like, for example.

On the other hand, during a manufacturing process of the battery 1, there is a case that moisture derived from water vapor in the environment may get intruded inside the case 2 to some extent. Also during a process of using the battery 1, there is a case that moisture may get intruded inside from outside when the hermetic sealing property of the case 2 is low. Therefore, even if the electrolytic solution 6 is based on non-aqueous solvent, it cannot be necessarily confirmed that there is no moisture existed.

Intrusion of moisture in the electrolytic solution 6 results in deprival of hydrogen from water molecules by fluorine in the electrolytic solution 6 and results in generation of hydrogen fluoride. Generation of hydrogen fluoride is a factor of obstructing the originally expected endurance of the resin member 10. This is because the glass is generally a compound with excellent chemical stability but is decomposed by hydrogen fluoride. Accordingly, when hydrogen fluoride generated in the electrolytic solution 6 comes to contact with the inner exposed surface 11 of the resin member 10, the glass filler in the resin member 10 is attacked by the hydrogen fluoride. The glass filler gets eluted from the resin member 10, and thus the linear expansion coefficient and the elastic modulus of the resin member 10 approach the original linear expansion coefficient and the elastic modulus of the base resin. This could lead to earlier degradation of the resin member 10 than expected.

However, in the present embodiment, the group 2 elements added to the glass filler inhibits dissolution of the glass due to the hydrogen fluoride. This is because the hydrogen fluoride more preferentially attacks the group 2 elements than the silicon oxide. In other words, the group 2 elements trap the hydrogen fluoride to protect the silicon oxide from the attack by the hydrogen fluoride. The group 2 elements themselves turn fluorides by trapping the hydrogen fluoride. Further, water is generated by this reaction.

Therefore, existence of the group 2 elements achieves restraint of dissolution of the glass due to the hydrogen fluoride. Thus, the endurance of the resin member 10 that has been originally expected can be maintained. Accordingly, in the battery 1 of the present embodiment, even if moisture gets intruded in the case 2, degradation in the endurance of the resin member 10 caused by moisture intrusion rarely occurs. In the present embodiment, therefore, insulation property and hermetic sealing property between the lid 5 and the terminal members 7 can be maintained for a long term owing to the resin member 10.

A compounded amount of the group 2 elements in the glass filler is preferably 0.12% or more and 65% or less at a number of atoms ratio of the group 2 elements to silicone in the component elements. When a plurality of types of the group 2 elements such as magnesium and calcium are included, this numerical range means a sum of the compounded amount of the group 2 elements. If the compounded amount of the group 2 elements is insufficient, the effect of improvement in the endurance is not enough. If the compounded amount of the group 2 elements are excessive, obstacle such as difficulty in shaping the glass into a short-fiber form could be caused to result in degradation in productivity.

When at least a part of the group 2 elements is magnesium, the compounded amount thereof is preferably 0.1% or more and 25% or less at a mass ratio to the silicone. Further, when at least a part of the group 2 elements is calcium, the compounded amount thereof is preferably 0.17% or more and 81% or less at the mass ratio to silicone.

The present inventors have performed a test for evaluating endurance of the resin member 10 of the present embodiment, and results of the test is now explained. The results to be explained are the following two items.
Erosion depth after the endurance test
Changes in the elastic modulus before and after the endurance test

The following two filler-contained resins are both formed to be plate-shaped samples with a thickness of 1 mm for the test.

### EXAMPLE

Base resin: PPS resin

Material of glass filler: magnesium compounded by 1.9% to 25% at a mass ratio to silicone

Shape of glass filler: a short-fiber-like shape with 10 μmφ×0.3 mm length

### Comparative Example

Base resin: the same as above

Material of glass filler: no compound of the group 2 elements

Shape of glass filler: the same as above

In the test, these samples of the resin member are impregnated in the electrolytic solution under the following condition.

Types of solvents of the electrolytic solution: mixture of ethylene carbonate and diethyl carbonate at a mass ratio of 1:1

Type and concentration of electrolyte: lithium hexafluorophosphate, 1 mol/lit.

Water content amount: 1200 ppm which corresponds to the amount at elapse of 25 years since start of using a battery

Temperature of the electrolytic solution at the time of impregnation: three references of 25° C., 65° C., and 80°° C.

Impregnation time: 20 days

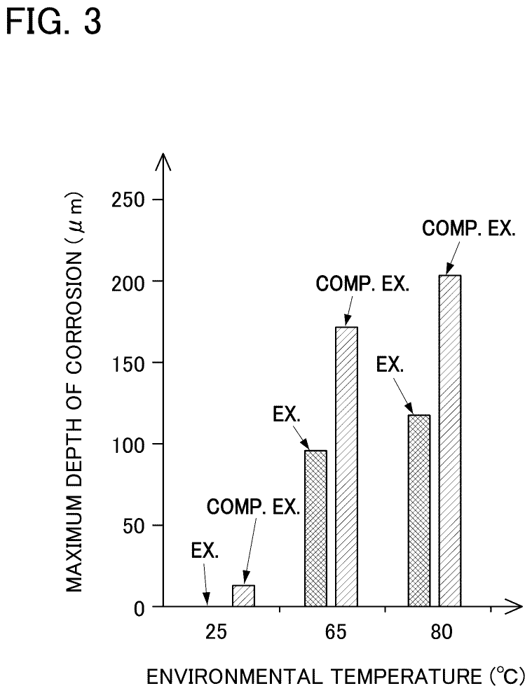

For evaluation of the erosion depth after the endurance test, a corroded state of the glass filler in the post-impregnation sample is evaluated. Specifically, the maximum depth from a surface where the complete disappearance of the glass filler occurred at the section of the sample is evaluated. The surface of the sample corresponds to the inner exposed surface 11 of the resin member 10. This evaluation has been made by observing the section of the sample by use of a scanning electron microscope. The evaluation results are shown in FIG. 3. In FIG. 3, the maximum depth of corrosion after impregnation indicated on a vertical axis is shown by contrasting the example and the comparative example per each temperature of the above-mentioned three references at the time of impregnation.

The results shown in FIG. 3 can be concluded as follows.
As a whole, the higher the temperature at the impregnation is, the corrosion advances to a deeper region.
Under any temperature condition, the depth of the corrosion is shallower in the example than in the comparative example. Herein, the corrosion depth in the example where the sample has been impregnated at 25° C. is zero.

Accordingly, in the example in which magnesium is compounded, the glass filler is inhibited from corrosion under any temperature conditions as compared to the comparative example in which no magnesium is compounded. This is considered to be because the glass is restrained from dissolution by the hydrogen fluoride owing to the magnesium added in the example.

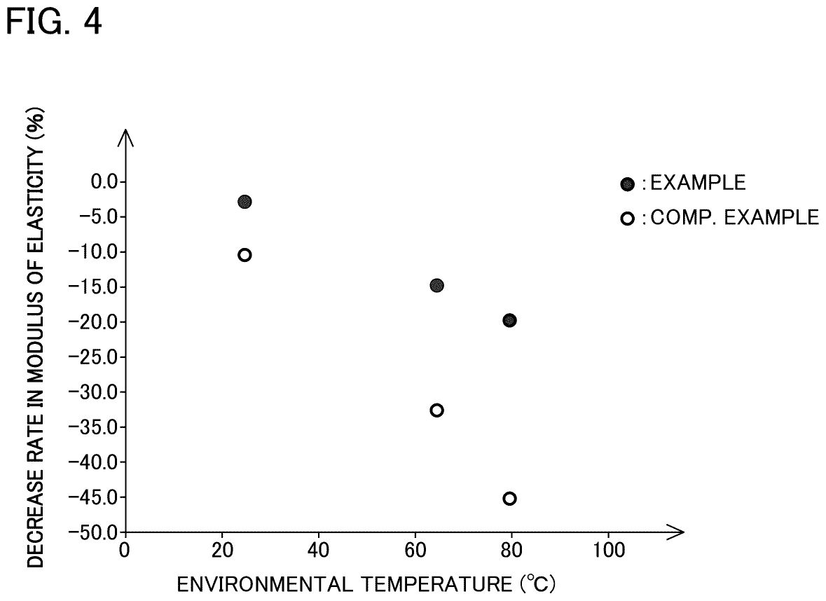

In the evaluation of changes in the elastic modulus before and after the endurance test, it has been evaluated how much the elastic modulus of the sample after impregnation has been lowered with respect to the elastic modulus of the sample before impregnation. For evaluation, the sample before impregnation and the sample after impregnation are measured respectively with their elastic modulus, and the reduction rates are calculated. Results of calculation are indicated in FIG. 4. A vertical axis of FIG. 4 indicates a decline rate of the elastic modulus of the sample after impregnation by a negative value with reference to the elastic modulus of the sample before impregnation. The lower the value of the vertical axis goes in FIG. 4, the more considerable the decline in the elastic modulus due to the impregnation becomes. FIG. 4 also indicates the results per each temperature of the three references during impregnation by contrasting the example and the comparative example.

The results in FIG. 4 can be concluded as follows.
As a whole, the higher the temperature at the time of impregnation is, the larger the reduced amount of the elastic modulus due to impregnation tends to be.
Under any temperature conditions, the reduced amount in the elastic modulus is smaller in the example than in the comparative example.

According to FIG. 4, in the example compounded with magnesium, as compared to the comparative example compounded with no magnesium, reduction in the elastic modulus due to the impregnation has been restrained under any temperature conditions. This is considered to be because dissolution of the glass due to the hydrogen fluoride is restrained by magnesium added in the example. In other words, while the glass filler has been considerably lost by impregnation in the comparative example, the glass filler in the example is considered to be maintained quite a bit even after impregnation.

The present inventors have also performed a test for examining intrusion of fluorine due to impregnation of the resin member 10 to the electrolytic solution in the present embodiment. For performing this test, four patterns of resins containing glass filler, each of which has contents as indicated in a table 1, are prepared as samples. Each shape of the samples is same as the one mentioned above. Each numerical value in a column of “percent by mass (%)” in the table 1 indicates a mass ratio of the respective elements with respect to the mass of the entire glass including oxygen and others. Each numerical value in a column of “mass ratio (%)” indicates a relative mass ratio of only the respective elements in the glass. Each numerical value in a column of “number of atoms ratio (%)” is a value of the ratio by number of atoms converted from the mass ratio based on an atomic amount of the respective elements.

TABLE 1

| | | | | Mass ratio (%) | | | Number of atoms ratio (%) | | |
|---|---|---|---|---|---|---|---|---|---|
| | Percent by mass | | | | | (Mg + Ca)/ | | | (Mg + Ca)/ |
| | Si | Mg | Ca | Mg/Si | Ca/Si | Si | Mg/Si | Ca/Si | Si |
| Sample A | 26.9 | 0 | 16.5 | 0.00 | 61.34 | 61.34 | 0.00 | 42.94 | 42.94 |
| Sample B | 23.0 | 1.5 | 18.6 | 6.52 | 80.87 | 87.39 | 7.61 | 56.61 | 64.22 |
| Sample C | 23.9 | 5.5 | 8.8 | 23.01 | 36.82 | 59.83 | 26.85 | 25.77 | 52.62 |
| Sample D | 25.8 | 0.5 | 18.1 | 1.94 | 72.87 | 74.81 | 2.26 | 49.11 | 51.37 |

A sample A of four types of samples in the table 1 is the resin only containing calcium but not containing magnesium as the group 2 elements. Samples B, C, and D are the resin containing both magnesium and calcium as the group 2 elements. Among these samples, the sample B has a compounded amount of calcium closer to an upper limit of the above-mentioned desirable range of the mass ratio, and the compounded amount of the sum of magnesium and calcium is closer to the upper limit of the above-mentioned desirable range at the number of atoms ratio. The sample C has the compounded amount of magnesium closer to the upper limit of the above-mentioned desirable range of the mass ratio, and the compounded amount of magnesium and the compounded amount of calcium are almost same to each other in the number of atoms ratio. The sample D is made to have the sum of the compounded amount of magnesium and the compounded amount of calcium at the number of atoms ratio as almost same with that of the sample C, and thus the compounded amount of magnesium is reduced and the compounded amount of calcium is increased.

These four types of samples are impregnated in the electrolytic solution, and each intrusion depth of fluorine into the samples after impregnation is measured. For each type, a plurality of samples are provided for measurement. The electrolytic solution provided herein is the one same with the solution presented in the above-mentioned explanation of the subject test. Measurement of the intrusion depth of fluorine is made by a scanning electron microscope provided with an X-ray elemental analyzer. Specifically, a section of the sample after impregnation is observed by the subject electron microscope and a distribution of fluorine is mapped by the X-ray elemental analyzer to measure the maximum depth of a point where existence of fluorine is detected from a surface. This is a different index from the above-mentioned “erosion depth”, and this index generally represents a larger value than the “erosion depth” under the same condition.

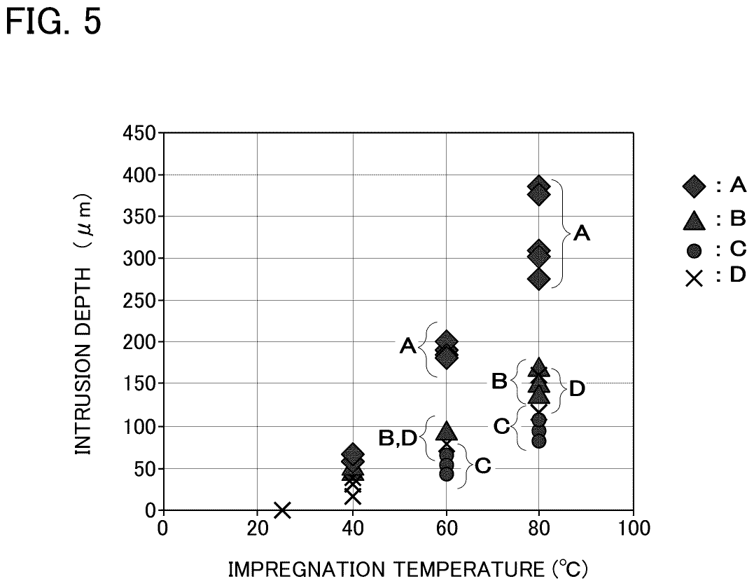

FIG. 5 is a graph showing a relationship between the measured intrusion depth of fluorine and the temperature of the electrolytic solution at the time of impregnation. A vertical axis of FIG. 5 represents the intrusion depth, and a lower part in the axis means less intrusion and excellence in resistance to the electrolytic solution. In measurement shown in FIG. 5, four references of 25° C., 40° C., 60° C., and 80° C. are set as the temperature at the time of impregnation. Impregnation time is set as 20 days. Five samples are prepared for each type of samples and for each temperature reference, and the measurement is performed at the time of impregnation and the time thereafter to record the maximum intrusion depth in the respective samples.

It is confirmed by FIG. 5 that the higher the temperature at the time of impregnation is, the larger the intrusion depth of fluorine tends to be. Further, among the samples of the four types, the sample A not containing magnesium tends to be large in the intrusion depth as compared to the samples B, C, and D each of which contains magnesium. From these results, magnesium is considered to be more effective than any other group 2 elements among the group 2 elements. However, it can be said that the sample A also achieves restraint of fluorine intrusion since a resin containing no any group 2 elements results in far deeper intrusion of fluorine to an extent exceeding a range of the vertical axis indicated in FIG. 5.

According to the present embodiment as explained in detail above, in the battery 1 in which the electrolytic solution 6 contains fluorine, a compound material compounded with glass filler, in which the group 2 element is added, is used as the resin member 10 sealing the through hole 9 for passing the terminal member 7. Thus, even if moisture gets intruded in the electrolytic solution 6, degradation in the resin member 10 caused by the intrusion of moisture can be restrained. In other words, addition of the group 2 element to the glass filler improves endurance of the resin member 10. As a result of this, the lithium-ion battery 1, in which degradation in the resin member 10 is not accelerated even if the non-aqueous electrolytic solution 6 containing fluorine is used, can be produced.

The present embodiment and the examples are only illustration and give no any limitation to the present disclosure. The present disclosure may naturally be made with various improvements and modifications without departing from the scope of disclosure. For example, in the embodiment, a flat-rectangular-shaped battery as shown in FIG. 1 is exemplified as a battery 1 which is an adopted object of the present disclosure. Alternatively, batteries having any other outer shapes such as a cylindrical shape may be adopted other than the one described in the present embodiment.

Further, in the above embodiment, the resin member 10 as an applied portion of the present disclosure is exemplified as a member for insulating the terminal member 7 and the lid 5. The applied portion is not limited to this and the present disclosure may be applied to a resin material formed in any other portions in a battery. A resin material in other portions is exemplified as a closing resin in a case of closing a liquid inlet by a resin material. Further, the housing 4 of the case 2 may be an insulating product, and thus the housing 4 itself may be configured with a resin member applied with the present disclosure. Further, the resin member of the present disclosure may be used as a sealing resin between a cylindrical case and a circular lid when a battery is of a cylindrical shape.

In the above embodiment, the terminal member 7 and the outer terminal 8 are connected outside the case 2. Alternatively, the terminal member 7 and the outer terminal 8 may be integrally configured. Inside the case 2, not only direct connection of one end of the terminal member 7 to the electrode body 3, but also indirect connection via another current collecting member may be adopted.

### REFERENCE SIGNS LIST

1 Battery
2 Case
3 Electrode body
4 Housing
5 Lid
6 Electrolytic solution
7 Terminal member
10 Resin member
11 Inner exposed surface

What is claimed is:

1. A lithium-ion battery comprising:
a case;
an electrode body and an electrolytic solution housed inside the case; and
a resin member being fixed to the case and having an inner exposed surface which is exposed inside the case, wherein
the electrolytic solution is a non-aqueous electrolytic solution containing fluorine,
the resin member includes glass filler formed of glass which contains silicon oxide as a main body and is added with group 2 elements, and
a number of atoms ratio of the group 2 elements to silicone in component elements of the glass filler is 0.12% or more and 65% or less.

2. The lithium-ion battery according to claim 1, wherein
at least a part of the group 2 elements is magnesium, and
a mass ratio of magnesium to silicone in the component elements of the glass filler is 0.1% or more and 25% or less.

3. The lithium-ion battery according to claim 1, wherein
at least a part of the group 2 elements is calcium, and
a mass ratio of calcium to silicone in the component elements of the glass filler is 0.17% or more and 81% or less.

4. The lithium-ion battery according to claim 1, wherein
the lithium-ion battery is provided with a terminal member that is connected to the electrode body inside the case and penetrates the case to be partly exposed outside the case, and
the resin member is configured to insulate the case and the terminal member.

5. The lithium-ion battery according to claim 2, wherein
the lithium-ion battery is provided with a terminal member that is connected to the electrode body inside the case and penetrates the case to be partly exposed outside the case, and
the resin member is configured to insulate the case and the terminal member.

6. The lithium-ion battery according to claim 3, wherein
the lithium-ion battery is provided with a terminal member that is connected to the electrode body inside the case and penetrates the case to be partly exposed outside the case, and
the resin member is configured to insulate the case and the terminal member.
